(19) United States
(12) Patent Application Publication
(10) Pub. No.: US 2023/0422387 A1
(43) Pub. Date: Dec. 28, 2023

(54) CYCLOTRON TARGET AND LANTHANUM THERANOSTIC PAIR FOR NUCLEAR MEDICINE

(71) Applicant: The Governors of the University of Alberta, Edmonton (CA)

(72) Inventors: Bryce Jared Braun NELSON, Edmonton (CA); John S. WILSON, Edmonton (CA); Jan Daniel ANDERSSON, Edmonton (CA); Frank WUEST, Edmonton (CA)

(21) Appl. No.: 18/037,196

(22) PCT Filed: Nov. 12, 2021
(86) PCT No.: PCT/CA2021/051612

§ 371 Date: May 16, 2023

Related U.S. Application Data
(60) Provisional application No. 63/114,267, filed on Nov. 16, 2020.

(51) Int. Cl. H05H 6/00; G21G 1/10; G21G 4/08

(52) U.S. Cl. CPC H05H 6/00; G21G 1/10; G21G 4/08

(57) ABSTRACT

Generally, the present disclosure provides a sealed solid cyclotron target for producing radionuclides on medical cy-clotrons. In some aspects, the cyclotron target is useful for producing radionuclides using hazardous or radioactive target material.

### CROSS REFERENCE TO RELATED APPLICATION

This application claims priority to United States Patent Application U.S. 63/114,267, filed Nov. 16, 2020, the entire contents of which is hereby incorporated by reference.

### FIELD

Generally, the present disclosure provides a sealed solid cyclotron target for producing radionuclides on medical cyclotrons. In some aspects, the cyclotron target is useful for producing radionuclides using hazardous or radioactive target material.

### BACKGROUND

Theranostics in nuclear medicine is a technique whereby a site specific pharmaceutical is radiolabeled first with a radionuclide for diagnostic imaging. After analysis, the same pharmaceutical is labelled with a particle emitting radionuclide for therapeutic application [1]. The complementary radionuclides used are called theranostic pairs. It is essential that the two radionuclides have very similar chemical properties with the ideal case being that they are different isotopes of the same element. Auger electron-emitting isotopes have potential as a high linear energy transfer (LET) therapeutic agent to destroy cancer cells by depositing their ionizing emission energy over a very short path length, damaging DNA by inducing various types of DNA damage, including double-strand breaks. This holds advantages over lower LET therapy such as β⁻ therapy where emissions can travel over 1 cm, and may unnecessarily irradiate healthy tissue [2,3]. High LET Auger electron emissions have achieved encouraging clinical results, with ¹¹¹In-DTPA-octreotide and ¹²⁵I-IUdR causing tumor remissions in patients with lower normal tissue toxicity, and improvements in the survival of glioblastoma patients using ¹²⁵I-mAb 425 with minimal normal tissue toxicity [4]. A recently developed theranostic pair is ^{132/135}La, where positron emissions from ¹³²La are used for PET imaging while the Auger electrons from 135 La have the potential for use in Auger electron therapy (AET) [5,6,7]. Theranostic La pairs are not only inherently useful but also can serve as surrogates for potential future study relating to ²²⁵AC alpha-particle therapy. ²²⁵Ac-labeled compounds have seen significant recent clinical successes in treating aggressive tumor metastases [2,8].

However, ^{132/135}La has limitations for PET imaging due to its fundamental positron and gamma emission properties, and current cyclotron production methods. The average and maximum ¹³²La positron energies of 1.29 MeV and 3.67 MeV are significantly higher than those of other commonly used PET isotopes such as ¹⁸F (Eₘₑₐₙ 0.250 MeV, Eₘₐₓ=0.634 MeV), ⁶⁴cu (Eₘₑₐₙ=0.278 MeV, Eₘₐₓ=0.653 MeV), ⁶⁸Ga (Eₘₑₐₙ=0.829 MeV, Eₘₐₓ=1.90 MeV), or ⁴⁴Sc (Eₘₑₐₙ=0.632 MeV, Eₘₐₓ=1.47 MeV) [9]. The higher positron energy of ¹³²La implies reduced PET image spatial resolution for tumor imaging, especially when imaging smaller tumors and metastases. Furthermore, ¹³²La emits high abundance gamma rays within typical 511 keV PET scanner energy windows that can contribute to spurious coincidences, as well as high energy gamma rays that may complicate handling.

Using ^{nat}Ba target material, current ¹³²La cyclotron production methods via ¹³²Ba(p,n)¹³²La require long irradiation times and generate reduced activity due to the very low natural abundance of ¹³²Ba (0.1%).

### SUMMARY

In one aspect, there is described a cyclotron target, comprising:
a target backing (1), comprising an inner surface and an outer surface, the inner surface defining a target material depression (3) sized to receive a target material pellet, the inner surface defining an annular groove (2) sized to receive a wire seal element,
a wire seal element (6) disposed within the annular groove (2),
a target cover (4) removably fixed to the target backing (1) and defining an inner volume said target cover (4), and optionally comprising a removal tab for removing at least a portion of said target cover (4) from said target backing (1).

In one aspect, further comprising a target material pellet disposed within said target material depression (3).

In one example, said target backing comprises, consists of, or is, silver, copper, niobium, gold, aluminum, or platinum.

In one example, said target backing is generally circular, having a diameter of about 22 mm to about 44 mm, and a thickness of about 1 mm to about 2 mm.

In one example, the target material depression (3) is generally circular with a diameter of about 10-15 mm and depth up to about 0.4 mm.

In one example, the annular groove comprises a 1-2 mm wide annulus with an inner diameter of about 15-25 mm, an outer diameter of about 16-27 mm, and a depth of about 0.1-0.6 mm.

In one example, the wire seal element has a diameter of about 1-2 mm.

In one example, the wire seal element comprises, consists of, or is, indium.

In one example, the target material pellet comprises a metallic pellet, oxide, salt, or spotted on as a liquid and allowed to dry.

In one example, the target material is a target material pellet between about 0-15 mm in diameter and about 0.4-1 mm thick.

In one example, the target cover comprises, consists of, or is, aluminum or copper.

In one example, the target cover has a diameter of about 20-35 mm and a thickness of about 0.025-0.250 mm.

In one aspect there is provided a method of manufacturing a cyclotron target, comprising:
providing a target backing (1) comprising an inner surface and an outer surface, the inner surface defining a target material depression (3) sized to receive a target material pellet, the inner surface defining an annular groove (2) sized to receive a wire seal element.
securing a target material in the target materials depression (3),
placing a wire seal element in the annular groove (2),
securing a target cover to the target backing (1).

In one example, the securing of the target materials comprises applying force to said target materials when disposed in said target material depression.

In one example, said force is applied is about 20 kN.

In one example, said force is applied using a hydraulic press.

In one example, securing the target cover comprises applying a force of about 25 kN to target cover on the inner surface of target backing.

In one example, said force is applied using a hydraulic press.

In one aspect there is provided a method of producing a radionuclide for use in position emission tomography (PET), comprising: irradiating a cyclotron target of any one of claims 1 to 12 at 22 MeV, for 25-200 min with a maximum proton beam current of 20 μA at current densities of 25.5 μA/cm².

In one example, said irradiating is carried out using a 24 MeV TR-24 cyclotron.

In one aspect there is provided method of producing ^{133/135}La, comprising: irradiating a cyclotron target of any one of claims 1 to 12 at about 22 MeV, wherein the target material is ^{nat}Ba metal.

In one aspect there is provided a kit, comprising:
a target backing (1), comprising an inner surface and an outer surface, the inner surface defining a target material depression (3) sized to receive a target material pellet, the inner surface defining an annular groove (2) sized to receive a wire seal element,
a wire seal element (6) disposed within the annular groove (2),
a target cover (4) removably fixed to the target backing (1) and defining an inner volume said target cover (4), and optionally comprising a removal tab for removing at least a portion of said target cover (4) from said target backing (1).

In one aspect further comprising a target material pellet disposed within said target material depression (3).

In one example, said target backing comprises, consists of, or is, silver, copper, niobium, gold, aluminum, or platinum.

In one example, said target backing is generally circular, having a diameter of about 22 mm to about 44 mm, and a thickness of about 1 mm to about 2 mm.

In one example, the target material depression (3) is generally circular with a diameter of about 10-15 mm and depth up to about 0.4 mm.

In one example, the annular groove comprises a 1-2 mm wide annulus with an inner diameter of about 15-25 mm, an outer diameter of about 16-27 mm, and a depth of 0.1-0.6 mm.

In one example, the wire seal element has a diameter of about 1-2 mm.

In one example, the wire seal element comprises, consists of, or is, indium.

In one example, the target material pellet comprises a metallic pellet, oxide, salt, or spotted on as a liquid and allowed to dry.

In one example, the target material is a target material pellet between about 0-15 mm in diameter and about 0.4-1 mm thick.

In one example, the target cover comprises, consists of, or is, aluminum or copper.

In one example, the target cover has a diameter of about 20-35 mm and a thickness of about 0.025-0.250 mm.

### BRIEF DESCRIPTION OF THE FIGURES

Embodiments of the present disclosure will now be described, by way of example only, with reference to the attached Figures.

FIG. 1 depicts nuclear reaction cross-section simulation data of the proton-induced nuclear reaction on ^{132/134/135/136/137}Ba for ^{132/133/135}La [12].

FIG. 2 depicts nuclear reaction cross-section simulation data of the proton-induced nuclear reaction on ^{132/134/135/136/137}Ba for ^{132/133/135}La weighted for ^{nat}Ba isotopic abundance [12].

FIG. 3 depicts a front view of the sealed solid cyclotron target highlighting the indium wire annulus and the target material depression.

FIG. 4 depicts a back view of the sealed solid target.

FIG. 5 depicts a front view of a completed sealed solid target with the protruding aluminum cover.

FIG. 6 depicts a side view of the sealed solid target and its components prior to complete assembly.

FIG. 7 depicts a front view of the sealed solid cyclotron target components.

FIG. 8 depicts a target process flow.

### DETAILED DESCRIPTION

Generally, the present disclosure provides a sealed solid cyclotron target for producing radionuclides on medical cyclotrons. In some aspects, the cyclotron target is useful for producing radionuclides using hazardous or radioactive target material.

In one aspect, there is provided a cyclotron target, comprising: a target backing (1), comprising an inner surface and an outer surface, the inner surface defining a target material depression (3) sized to receive a target material pellet, the inner surface defining an annular groove (2) sized to receive a wire seal element, a wire seal element (6) disposed within the annular groove (2), and a target cover (4) removably fixed to the target backing (1) and defining an inner volume said target cover (4), and optionally comprising a removal tab for removing at least a portion of said target cover (4) from said target backing (1).

In another aspect, there is provided a cyclotron target comprising: a target backing (1), comprising an inner surface and an outer surface, the inner surface defining a target material depression (3) sized to receive a target material pellet, the inner surface defining an annular groove (2) sized to receive a wire seal element, a wire seal element (6) disposed within the annular groove (2), and a target cover (4) removably fixed to the target backing (1) and defining an inner volume said target cover (4), a target material pellet disposed within said target material depression (3), and optionally comprising a removal tab for removing at least a portion of said target cover (4) from said target backing (1).

In some examples, said target backing comprises, consists of, or is, silver. In other examples, said target backing comprises, consists of, or is gold, platinum, or aluminum.

In some examples, said target backing is generally, but not limited to a circular shape, having a diameter generally of about 22 mm to about 44 mm, and a thickness of about 1 mm to about 2 mm.

In some examples, the target material depression (3) is generally circular with a diameter of about 10-15 mm and depth up to about 0.4 mm.

In some examples, the annular groove comprises an about 1-2 mm wide annulus with an inner diameter of about 15-25 mm, an outer diameter of about 16-27 mm, and a depth of about 0.1-0.6 mm.

In some examples, the wire seal element has a diameter of about 1-2 mm.

In some examples, the wire seal element comprises, consists of, or is, indium.

In some examples, the target material pellet comprises a metallic pellet, oxide, salt, or spotted on as a liquid and allowed to dry.

In some examples, the target material is a target material pellet between about 0-15 mm in diameter and about 0.4-1 mm thick.

In some examples, the target cover comprises, consists of, or is, aluminum. In other examples, the target cover comprises, consists of, or is copper.

In some examples, the target cover has a diameter of about 20-35 mm and a thickness of about 0.025-0.250 mm.

In a specific example, there is described a silver-aluminum-indium target assembly

The target assembly backing can be made of any metal with sufficient thermal conductivity, such as silver, copper, or niobium. Using a silver target backing as opposed to other metals such as platinum allows for low-cost target manufacturing and has demonstrated minimal Cadmium-107/109 nuclear by-products, allowing for multiple reuses of the target backing. The aluminum cover facilitates easy removal for processing via its peel-off tab, avoiding complex target transfer systems.

In some example, the cyclotron target described herein is suitable for production of a variety of radionuclides for use in positron emission tomography (PET) such as radioscandium (scandium-44/47), radiolanthanum (lanthanum-132/133/135), radioyttrium (yttrium-86), radiolead (lead-201/203) by cyclotron proton beam bombardment of reactive and water-soluble target materials (barium/calcium/strontium metal, barium/calcium/strontium/thallium oxide).

The cyclotron target described herein also permits production of actinium-225, an attractive alpha particle emitting cancer therapeutic radionuclide undergoing clinical trials, by proton bombardment of radioactive radium-226 chloride target material.

Method of the invention are conveniently practiced by providing the compounds and/or compositions used in such method in the form of a kit. Such kit preferably contains the composition. Such a kit preferably contains instructions for the use thereof.

To gain a better understanding of the invention described herein, the following examples are set forth. It should be understood that these examples are for illustrative purposes only. Therefore, they should not limit the scope of this invention in anyway.

### Examples

Abstract

This study reports the high-yield production of a novel ^{133/135}La theranostic pair at a 22 MeV proton beam energy as an attractive alternative to the recently introduced ^{132/135}La pair, demonstrating over an order of magnitude production increase of ^{133/135}La (231±8 MBq ¹³³La and 166±5 MBq ¹³⁵La at End of Bombardment (EOB)) compared to 11.9 MeV production of ^{132/135}La (0.82±0.06 MBq ¹³²La and 19.0±1.2 MBq ¹³⁵La) for 500 μA·min irradiations. A new sealed solid cyclotron target is introduced, which is fast to assemble, easy to handle, storable, and contains reusable components. Radiolabeling macrocyclic chelators DOTA and macropa ^{133/135}La product achieved full incorporation, with respective apparent ¹³³La molar activities of 33±5 GBq/μmol and 30±4 GBq/μmol. PET centers with access to a 22 MeV capable cyclotron could produce clinically-relevant doses of ^{133/135}La, via ^{nat}Ba irradiation, as a standalone theranostic agent for PET imaging and Auger electron therapy. With lower positron energies and less energetic and abundant gamma rays than ⁸⁶Ga, ⁵⁴⁴Sc and ¹³²La, ¹³³La appears to be an attractive radiometal candidate for PET applications requiring a higher scanning resolution, a relatively long isotopic half-life, ease of handling, and a low patient dose.

In one aspect, the present work describes high yield ^{133/135}La production through 22 MeV proton irradiation of ^{nat}Ba metal encapsulated within a convenient sealed cyclotron target. Irradiating ^{nat}Ba at 22 MeV generates much higher yields of ^{133/135}La compared to ^{132/135}La production at 11.9 MeV and bypasses the majority of ¹³²La production, avoiding contributions from its higher energy positron emissions. ¹³³La has average and maximum positron energies of 0.461 MeV and 1.02 MeV, respectively, that are lower than those of ¹³²La and other PET isotopes such as ⁶⁸Ga and ⁴⁴Sc. Gamma emissions from 133 La are low intensity and energy, falling well outside the typical PET scanner energy window. These features of ¹³³La simplify handling and reduce patient dose. This novel ^{133/135}La isotope system and its production method have the potential to improve the image quality of smaller and metastatic tumors and allow clinically relevant production of ^{133/135}La via shorter cyclotron beamtime irradiations without requiring isotopically enriched Ba target material. High-yield production is possible via proton irradiation of ^{nat}Ba on a cyclotron capable of attaining 22 MeV beam energies. The favorable ¹³³La positron and gamma-ray emission properties suggest that ^{133/135}La has significant potential as a theranostic pair substitute for ^{132/135}La.

Materials and Methods

Chemicals. Natural barium (99.99% trace metals basis) dendritic pieces, ACS reagent grade concentrated hydrochloric acid (37%) and nitric acid (70%), and ICP-OES elemental standards were purchased from Sigma-Aldrich (St. Louis, MO, U.S.A.). Silver rod (99.9%) was purchased from Metal Supermarkets (Mississauga, ON, Canada). Branched DGA resin (50-100 μm) was purchased from Eichrom (Lisle, IL, U.S.A.). NIST traceable γ-ray sources used for high-purity germanium detector (HPGe) energy and efficiency calibration were acquired from Eckert & Ziegler Isotopes (Valencia, California, U.S.A.). Thin-layer chromatography silica gel sheets were purchased from Merck (Darmstadt, HE, Germany).

High purity water (18 MΩ·cm) was obtained from a MilliporeSigma Direct-Q® 3 UV system (Burlington, MA, U.S.A.). The macrocyclic chelator DOTA was purchased from Macrocyclics (Plano, TX, U.S.A.), and the macrocyclic chelator macropa was purchased from MedChemExpress (Monmouth Junction, NJ, U.S.A.).

Instrumentation. Sample activity was measured using an Atomlab™ 500 Dose Calibrator (Biodex, Shirley, NY, U.S.A.). Radionuclidic purity was assessed using a GEM35P4-70-SMP high-purity germanium detector (ORTEC, Oak Ridge, TN, U.S.A.) with ORTEC GammaVision software. Elemental purity was assessed using a 720 Series ICP-OES (Agilent Technologies, Santa Clara, CA, U.S.A). A NEPTIS Mosaic-LC synthesis unit (Optimized Radiochemical Applications, Belgium) was used to separate and purify the ^{133/135}La from the dissolved Ba target solution. An AR-2000 Radio-TLC Imaging Scanner (Eckert & Ziegler, Hopkinton, MA, U.S.A.) was employed to quantify the fraction of chelator-bound ^{133/135}La after the reaction. The solid targets were manufactured using a Model 6318 hydraulic press (Carver, Wabash, IN, U.S.A.), and the ^{nat}Ba metal was pressed inside a 10 mm (I.D.) EQ-Die-10D-B hardened steel die (MTI Corporation, Richmond, CA, U.S.A.). A 590013A optical light microscope (Fisher Scientific, Waltham, MA, U.S.A.) was employed to inspect the seal integrity of each sealed solid target after manufacturing.

Cyclotron targetry and irradiation. Cyclotron targets were prepared from 200 mg of ^{nat}Ba metal, an Ag disc (24 mm diameter, 1.5 mm thick) cut from an Ag rod, In wire (1 mm diameter), and Al foil (25 μm thick). A 10 mm diameter depression was machined into the center of each disc to a 100 μm depth, and a 1 mm wide annulus with an inner diameter of 15 mm was machined to a depth of 100 μm. Using a method similar to the target production described in [10], ^{nat}Ba metal was quickly loaded into a hardened stainless steel die to minimize exposure to the atmosphere, and a force of 15 kN was applied using a hydraulic press, producing a 10 mm diameter pellet with a thickness of 0.8 mm. Pellets were produced in large quantities (>10/batch) and removed quickly from the die and sealed in a vial with an argon atmosphere to prevent oxidation during storage.

A 23 mm diameter Al foil cover was cut out with a flap extension to facilitate post-irradiation removal by peeling. Individual pellets were then placed in the central Ag disc depression and pressed at a force of 20 kN on the hydraulic press to secure the pellets in the depression. 5.5 cm of In wire was then laid into the annulus depression with 1 mm of overlap at the ends, the target assembly was quickly covered by the Al cover, and a force of 25 kN was applied using the hydraulic press to compress the In wire to form an air-tight bond between the Ag disc and Al cover. Following pressing, the target was observed under an optical light microscope to confirm target seal integrity, verifying there were no pinholes present in the Al cover. The target was stored under regular atmospheric conditions ready for on-demand irradiation.

Targets were irradiated at 22 MeV using a 24 MeV TR-24 cyclotron (Advanced Cyclotron Systems Inc., Richmond B.C., Canada) for 25-200 min with a maximum proton beam current of 20 μA at current densities of 25.5 μA/cm². A pneumatically actuated TA-1186 solid target assembly (Advanced Cyclotron Systems Inc., Richmond B.C., Canada) was used with the target disc perpendicular to the proton beam. O-rings within the assembly provided a helium gas seal on the front and water seal on the back for both cooling streams. The Ag target was designed to be at least 0.6 mm thick behind the 0.8 mm thick ^{nat}Ba pellet so that the exit beam energy leaving the Ag disc was degraded below 6 MeV, as simulated by SRIM 2013 [11]. This design consideration was to avoid the production of ¹³N(t_{1/2}=9.97 min) in the cyclotron cooling water circuit via the ¹⁶O(p,α)¹³N reaction. A 250 μm thick Ag degrader was added to the cyclotron beamline after the Al vacuum foil so that extracting the cyclotron beam at 17 MeV resulted in the target incident energy being degraded to 11.9 MeV. These irradiations at 11.9 MeV served to provide a comparison to the ^{132/135}La isotope production introduced by Aluicio-Sarduy et al. [5].

After allowing 1-2 h post-irradiation for decay of short-lived La isotopes, the target assembly was opened pneumatically, and the sealed target slid down a plastic guide tube into a lead shield. The lead shield was brought to a dose calibrator where its activity was measured, followed by placement into a lead castle containing a NEPTIS automated separation unit.

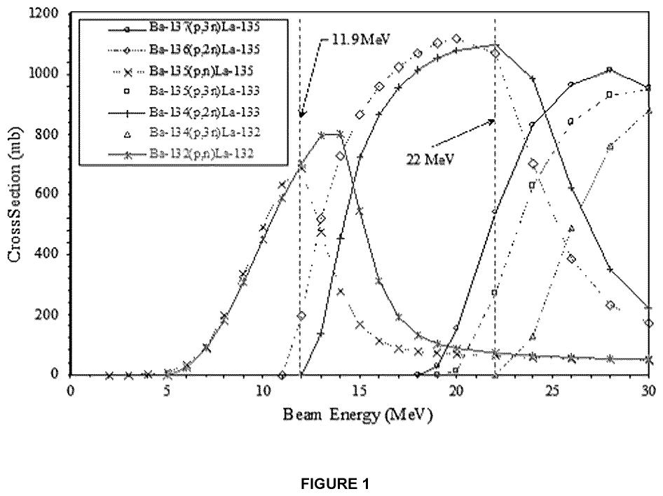

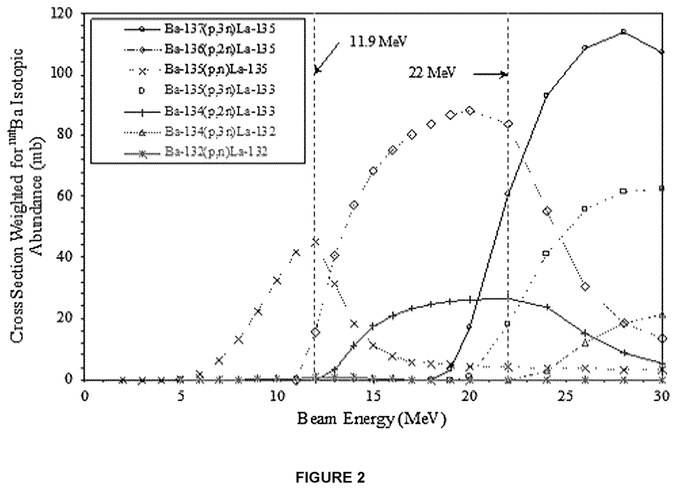

Nuclear reaction cross-sections of interest. Nuclear reaction cross sections simulated by TENDL 2019 for the ^{13x}Ba(p,xn)^{13x}La reactions of interest for ^{132/133/135}La are shown in FIG. 1. These same cross-sections, weighted for ^{nat}Ba isotopic abundance, are displayed in FIG. 2. The cyclotron beam was extracted at an energy of 22.2 MeV and degraded to a target incident energy on ^{nat}Ba of 22 MeV. The target incident energy of 22 MeV was selected using TENDL 2019 cross-section simulation data [12].

At a 22 MeV target incident beam energy, the simulation suggests significant ¹³⁵La and ¹³³La cross sections for the ¹³⁷Ba(p,3n) ¹³⁵La, ¹³⁶Ba(p,2n) ¹³⁵La, ¹³⁵Ba(p,3n) ¹³³La, and ¹³⁴Ba(p,2n) ¹³³La reactions. The ¹³²Ba(p,n) ¹³²La cross-section is over two orders of magnitude lower at 22 MeV compared to at 11.9 MeV, and the ¹³⁴Ba(p,3n) ¹³²La reaction cross-section does not begin until just above 22 MeV. Irradiating ^{nat}Ba at 22 MeV should therefore maximize the production of ¹³³La and ¹³⁵La, bypass the majority of ¹³²La production from the ¹³²Ba(p,n) ¹³²La reaction, and just avoid the onset of the significant ¹³⁴Ba(p,3n) ¹³²La reaction. Due to the higher natural abundances of ¹³⁴Ba (2.42%) and ¹³⁵Ba (7.59%) compared to ¹³²Ba (0.10%), ¹³³La production potential is much greater compared to ¹³²La, illustrated in the difference between the absolute and isotopically weighted cross-sections shown in FIG. 1 and FIG. 2, respectively.

To compare ^{133/135}La to ^{132/135}La in this study, irradiations were performed with a target incident beam energy of 11.9 MeV. FIG. 2 suggests irradiations at 11.9 MeV would result in the production of ¹³⁵La and ¹³²La via the ¹³⁵Ba(p,n) ¹³⁵La, ¹³⁶Ba(p,2n) ¹³⁵La, and ¹³²Ba(p,n) ¹³²La reactions, while just avoiding the start of ¹³³La production via the ¹³⁴La(p,2n) ¹³³La reaction, as also described by Aluicio-Sarduy et al. [5].

Other prominent cross sections at either 22 MeV or 11.9 MeV that are not depicted in FIG. 1 and FIG. 2 suggest unavoidable production of short-lived ¹³⁶La (t_{1/2}=8.7 min) via the ¹³⁶Ba(p,n) ¹³⁶La reaction, ¹³¹La(t_{1/2}=59.2 min) via the ¹³²Ba(p,2n) ¹³¹La reaction, ¹³⁴La (t_{1/2}=6.45 min) via the ¹³⁴Ba(p,n) ¹³⁴La and ¹³⁵Ba(p,2n) ¹³⁴La reactions, and ¹³⁶La(t_{1/2}=9.87 min) via the ¹³⁶Ba(p,n) ¹³⁶La and ¹³⁷Ba(p,2n) ¹³⁶La reactions. Significant cross sections are also present for the long-lived ¹³⁷La(t_{1/2}=6.2·10⁴ y) via the ¹³⁷Ba(p,n) ¹³⁷La and ¹³⁸Ba(p,2n) ¹³⁷La reactions, and ¹³⁸La(t_{1/2}=1.03·10¹¹ y) via the ¹³⁸Ba(p,n) ¹³⁸La reaction.

Automated separation of ^{133/135}La. ^{133/135}La was separated using modified aspects of a method described by Aluicio-Sarudy et al. [5]. The reactor vessel within its shield was transferred into the lead castle, the sealed target was opened by peeling back the Al cover, and a suction line was attached. The reactor vessel was filled with 10 mL of 18 MΩ·cm water, dissolving the ^{nat}Ba target material in 5 min. The Ag target disc was removed, and 10 mL of 6 N HNO₃ was added to the reactor to bring the overall concentration to 3 N HNO₃. 3 N HNO₃ was selected to reduce possible degradative effects of concentrated 6 N HNO₃ on the branched DGA resin. The target solution was withdrawn from the reactor and passed through two Acrodisc® 32 mm diameter filters with 5 μm Supor® membranes in parallel to capture any solid material such as ^{nat}Ba salts and oxides resulting from the dissolution stage. Following filtration, the target solution was passed through a SPE cartridge containing 0.25 g of branched DGA resin, and washed with 50 mL of 3 N HNO₃ to remove residual Ba and other metal impurities, followed by 5 mL of 0.5 N HNO₃. [^{133/135}La]LaCl₃ was eluted using 1 mL of 0.1 N HCl. Following a decay period of 5 days (to permit the decay of the short-lived ¹⁰⁷Cd and longer-lived ^{106m}Ag) the Ag disc was removed and cleaned in reagent grade 10 N HCl for reuse. For the comparative aspects, ^{132/135}La was separated using the same process.

Activity measurement and radionuclidic purity analysis. After separating the [^{133/135}La]LaCl₃ product, its radionuclidic purity was determined by gamma-ray spectroscopy using a high purity germanium (HPGe) detector. Calibrations for efficiency and energy were performed using NIST traceable Eckert & Ziegler Isotope Products Inc. γ-ray sources. Activities of La isotopes of interest were quantified using the efficiency-corrected HPGe measurements.

Elemental purity analysis. Inductively-coupled plasma optical emission spectrometry (ICP-OES) analysis was performed to quantify elemental impurities in the [^{133/135}La]LaCl₃ samples after allowing 10 days for residual ¹³⁵La to decay. The amounts of Zn, Fe, Al, Ba, Ag, In, Sn, and Cu were determined for each sample using calibrations obtained by measuring dilutions of elemental standards of known concentrations.

Radiolabeling of DOTA and macropa with ^{133/135}La. Following processing on the NEPTIS synthesis unit, the ^{133/135}La radionuclide was eluted in 1 mL of 0.1 N HCl. 500 μL of [^{133/135}La]LaCl₃ was withdrawn, and the activity was measured. This solution was diluted with 50 μL of NaOAc buffer (pH 9.0) to adjust to pH 4.5. 100 μL of the ^{133/135}La solution was reacted with 0.5 μg, 5 μg, and 20 μg of DOTA and macropa dissolved in 50 μL of 18 MΩ·cm water, at 80° C. for 30 min for DOTA and room temperature (22° C.) for 10 min for macropa. Each reaction solution was analyzed using radio-TLC on silica plates to determine radiochemical purity and incorporation with 0.1 M citric acid buffer as the mobile phase, with the R_{f} of free ^{133/135}La=0.9-1.0, [^{133/135}La]La-DOTA=0.1-0.2, and [^{133/135}La]La-macropa=0-0.1.

Results

Cyclotron targetry. Prior to longer irradiations, initial tests were performed with ^{nat}Ba targets at beam currents ranging from 1-20 μA to investigate target properties and durability. After irradiation and automated separation, HPGe analysis was performed on the Ag targets. For 11.9 MeV runs, analysis indicated small activities of ¹⁰⁷Cd (t_{1/2}=6.5 h) and ¹⁰⁹Cd (t_{1/2}=461.4 d) were produced via the ¹⁰⁷Ag(p,n) ¹⁰⁷Cd and ¹⁰⁹Ag(p,n) ¹⁰⁹Cd reactions. For 22 MeV runs, following the 3-h decay period, analysis indicated small activities of ¹⁰⁷Cd, ¹⁰⁹Cd, and ^{106m}Ag (t_{1/2}=8.28 d). For both beam energies in this study, the targets did not activate significantly, and the majority of the activity present was ¹⁰⁷Cd and ^{106m}Ag, which decayed significantly after several days. Following a 5-day decay period the targets were deemed acceptable for handling and reuse after placing the target in 10 N HCl to clean its surface. For all irradiations, none of the sealed Ag targets showed signs of physical degradation, with multiple target discs being reused upwards of 10 times.

^{133/135}La isotope production. Average activities (n=3) of La isotopes of interest at 11.9 MeV and 22 MeV are given as a function of time after EOB in Table 1, and several ratios of La isotopes of interest are given as a function of time after EOB in Table 2.

At 22 MeV, 500 μA·min runs (n=3) yielded 231±8 MBq ¹³³La, and 166±5 MBq ¹³⁵La. Saturated yields were 161±5.5 MBq/μA for 133 La, and 561±17 MBq/μA for ¹³⁵La. Significant amounts of ¹³⁴La and ¹³⁶La were present at EOB (1191±96 MBq and 3914±384 MBq, respectively), however owing to their short half-lives (6.45 min and 9.87 min, respectively), they decayed to negligible levels after 3-h post-EOB. Short-lived ¹³⁶La (8.7 min half-life) was observed and undetectable after the 3-h decay period. ¹³²La was produced (0.38±0.03 MBq at EOB), indicating its production reactions were largely bypassed. Co-production of ¹³¹La was observed (19.0±1.2 MBq at EOB), however owing to its relatively short half-life (59.2 min), it decayed significantly during the 3-h decay period. TENDL 2019 cross sections indicated production of long-lived ¹³⁷La and ¹³⁸La, however, this was not quantified due to their extremely long half-lives.

For the comparison ^{132/135}La production runs at 11.9 MeV, 500 μA·min runs (n=3) yielded 0.82±0.06 MBq ¹³²La and 17.9±0.8 MBq ¹³⁵La at EOB. Saturated yields were 0.70±0.03 MBq/μA for ¹³²La, and 60.6±2.8 MBq/μA for ¹³⁵La. Significant amounts of ¹³⁴La and ¹³⁶La were also observed at EOB (411±37 MBq and 2462±94 MBq, respectively), which decayed to undetectable levels after the 3-h decay period. Cross-sections generated by TENDL 2019 indicated the production of long-lived ¹³⁷La and ¹³⁸La. However, production was also not quantified owing to their long half-lives.

As shown in Table 2, the activity ratio of ¹³⁵La to ¹³³La at 22 MeV is much lower than the ratio of ¹³⁵La to ¹³²La at 11.9 MeV, resulting in a much greater PET imaging potential for a given total activity. At 22 MeV, the activity ratio of ¹³³La to ¹³²La remains large throughout the time intervals, suggesting that the production of the ¹³²La impurity was minimized.

TABLE 1
Average activities of La isotopes of interest at time-points after
EOB for 500 μA · min runs (n = 3) at 22 MeV and 11.9 MeV proton beam energies.

| | 22 MeV Irradiation | | | | | 11.9 MeV Irradiation | | |
|---|---|---|---|---|---|---|---|---|
| Time after | Activity of La Isotopes (MBq) | | | | | Activity of La Isotopes (MBq) | | |
| EOB (h) | ¹³⁵LA | ¹³³La | ¹³²La | ¹³¹La | ¹³⁴La + ¹³⁶La | ¹³⁵LA | ¹³²La | ¹³⁴La + ¹³⁶La |
| 0 | 166 | 231 | 0.38 | 19 | 5105 | 17.9 | 0.82 | 1394 |
| 1 | 160 | 193 | 0.33 | 9 | 60 | 17.3 | 0.71 | 15 |
| 2 | 155 | 162 | 0.29 | 4.7 | 0.86 | 16.7 | 0.62 | 0.22 |
| 3 | 149 | 136 | 0.25 | 2.3 | 0.013 | 16.1 | 0.53 | 0 |
| 4 | 144 | 114 | 0.21 | 11 | 0 | 15.6 | 0.46 | 0 |
| 6 | 134 | 80 | 0.16 | 0.28 | 0 | 14.5 | 0.35 | 0 |
| 8 | 125 | 56 | 0.12 | 0.07 | 0 | 13.5 | 0.26 | 0 |
| 12 | 108 | 25 | 0.068 | 0 | 0 | 11.7 | 0.15 | 0 |
| 24 | 71 | 3.3 | 0.01 | 0 | 0 | 7.7 | 0.03 | 0 |
| 48 | 30 | 0 | 0 | 0 | 0 | 3.3 | 0 | 0 |

TABLE 2
Activity ratios of La isotopes of interest at time-
points after EOB for 500 μA · min runs
(n = 3) at 22 MeV and 11.9 MeV proton beam energies.

| | 22 MeV | 22 MeV | 22 MeV |
|---|---|---|---|
| | Irradiation | Irradiation | Irradiation |
| | Activity Ratio | Activity Ratio | Activity Ratio |
| Time after | of ¹³⁵LA | of ¹³⁵LA | of ¹³⁵LA |
| EOB (h) | to ¹³³LA | to ¹³²LA | to ¹³²LA |
| 0 | 0.72 | 608 | 18 |
| 1 | 0.83 | 588 | 20 |
| 2 | 0.95 | 569 | 22 |
| 3 | 1.1 | 550 | 24 |
| 4 | 1.3 | 532 | 27 |
| 6 | 1.7 | 498 | 34 |
| 8 | 2.2 | 465 | 42 |
| 12 | 3.9 | 407 | 64 |
| 24 | 22 | 273 | 236 |
| 48 | 645 | 122 | 3172 |

Automated separation of ^{133/135}La. To determine dissolution time, several Ba targets were dissolved in the reactor with 10 mL of water, with the time required to completely dissolve the target ranging from 4 to 5 min. A dissolution time of 5 min was selected for production run separations to provide a sufficient time margin. The DGA resin was preconditioned with 3 N HNO₃ so the NEPTIS unit was prepared to receive the activity. The final product elution in 1 mL of 0.1 N HCl was calibrated to capture the maximum ^{133/135}La activity while avoiding excess dilution of the solution.

From the start of NEPTIS separation to the completion of product elution took ˜35 min. Over 88% of decay-corrected ^{133/135}La activity was consistently recovered from the automated synthesis. Residual decay activities were 3% of the total in the branched DGA resin, 3% in the dissolution reactor, 2% in the two reactor filters, with the remainder 4%) in the waste.

Radionuclidic and elemental purity analysis. For irradiations at 22 MeV beam energies, small amounts of ¹³¹La and ¹³²La were detected by HPGe gamma-ray spectroscopy performed on the ^{133/135}La eluate product after NEPTIS separation and a 3-h decay period. For 500 μA·min runs (n=3) at 22 MeV, the ¹³¹La and ¹³²La activities back-calculated to EOB were 19±1.2 MBq and 0.38±0.03 MBq, respectively.

The decay of ¹³³La resulted in small activities of its daughter nucleus ¹³³Ba (t_{1/2}=10.6 y). However, the resulting activity of ¹³³Ba after the complete decay of ¹³³La was approximately three orders of magnitude lower than the IAEA 1 MBq consignment level exemption limits [13]. No other radionuclidic impurities were observed in the ^{133/135}La product.

After allowing the ^{133/135}La eluate to decay for 10 days, an ICP-OES analysis was performed to investigate trace metal contaminants against a known mixture standard containing Zn, Fe, Al, Ba, Ag, In, Sn, and Cu. Metal impurities (n=3 runs) are presented in Table 3.

TABLE 3
Comparative ICP-OES elemental contaminant
analysis of the [^{133/135}La]LaCl₃ product.

| | Concentration |
|---|---|
| Metal | (ppb) |
| Zn | 76 ± 55 |
| Fe | 16.8 ± 11.7 |
| Al | 37 ± 19 |
| Ba | 1150 ± 360 |
| Ag | 1.9 ± 0.3 |
| In | 3.1 ± 0.9 |
| Sn | 126 ± 104 |
| Cu | 5.3 ± 0.4 |

Radiolabeling of DOTA and macropa chelators with ^{133/135}La. Table 4 summarizes the experimental results of ^{133/135}La radiolabeling with DOTA and macropa chelators. Radiolabeling with the tetraaza-macrocyclic chelator DOTA was performed with ^{133/135}La at 40° C. for 1 h and analyzed with radio-TLC. The [^{133/135}La]La-DOTA complex remained close to the TLC baseline (R f=0.1-0.2) while the unreacted ^{133/135}La migrated toward the solvent front (R f=0.9-1.0). The incorporation (n=3) of ^{133/135}La for DOTA labeling was 99.1±0.6%, 98.8±0.5%, and 97.9±1.2% for 20, 5, and 0.5 μg, respectively. Complete labeling of DOTA with ^{133/135}La was achieved up to 1.2 nmol of DOTA, with a corresponding apparent ¹³⁵La molar activity (n=3) of 47±9 GBq/μmol and ¹³³La molar activity (n=3) of 33±5 GBq/μmol.

Radiolabeling with the eighteen-membered macrocyclic chelator macropa was performed with ^{133/135}La at room temperature (22° C.) for 10 min, and analyzed with radio-TLC.

The [^{133/135}La]La-macropa complex remained at the TLC baseline (R_{f}=0-0.1) while the unreacted ^{133/135}La migrated toward the solvent front (R_{f}=0.9-1.0). The incorporation (n=3) of ^{133/135}La for macropa labeling was 99.3±0.5%, 99.5±0.7%, and 98.1±1.1% for 20, 5, and 0.5 μg, respectively. Complete labeling of macropa with ^{133/135}La was achieved up to 0.85 nmol of macropa, with a corresponding apparent ¹³⁵La molar activity (n=3) of 44±8 GBq/μmol and ¹³³La molar activity (n=3) of 30±4 GBq/μmol.

TABLE 4
^{133/135}La radiolabeling results with DOTA and macropa chelators.

| Chelator Mass | [133/135LA] La-DOTA | [133/135LA] La-macropa |
|---|---|---|
| (μg) | Incorporation (%) | Incorporation (%) |
| 20 | 99.1 | 99.3 |
| 5 | 98.8 | 99.5 |
| 0.5 | 97.9 | 98.1 |

### DISCUSSION

This study presents a high-yield cyclotron production avenue for a novel ^{133/135}La theranostic pair using a new sealed target design. Automated separation and purification produced a chemically pure product, with radiochemistry validating the feasibility of the ^{133/135}La theranostic pair using several common radiometal chelators.

Table 5 outlines the positron decay characteristics and notable gamma rays for ¹³³La, ¹³²La, and several other common isotopes used for PET. ¹³²La has a higher positron branching ratio (41.2%) compared to ¹³³La (7.2%), producing more 511 keV emissions for a given sample activity. Initially, this higher branching ratio would seem advantageous for PET imaging. However, positrons emitted by ¹³²La have a much higher 1.29 MeV average and 3.67 MeV maximum energy compared to ¹³³La positron emissions, which have a low, more desirable 0.463 MeV average and 1.02 MeV maximum positron energy. Since higher positron energies are correlated with lower PET imaging spatial resolution [14,15], this implies that ¹³³La would have superior PET imaging quality compared to ¹³²La.

The potential for improved PET scanning resolution of ¹³³La over ¹³²La could permit more accurate imaging to track the treatment of small tumors and metastases, complementing high LET targeted radionuclide therapy such as alpha particle or Auger electron therapy, which are both well suited for eradicating small metastatic tumors.

As shown in Table 5, ¹³²La has high energy gammas with a significant abundance, whereas ¹³³La has lower energy gammas with a much lower abundance. ¹³²La has a maximum gamma energy of 1909.91 keV at 9% abundance, whereas ¹³³La has a maximum gamma energy of 1099 keV with a 0.2% abundance. The lower energy and much lower abundance of the ¹³³La gamma rays should simplify handling and reduce the dose to patients upon injection for equivalent imaging activities, even though a greater activity of ¹³³La might be required due to the lower positron branching ratio of ¹³³La. In addition to potentially reducing the patient dose, the gamma ray energy distribution of ¹³³La could improve PET scanner imaging spatial resolution.

The ¹³²La 465 keV (76%) and 567 keV (14.7%) high abundance gamma rays are within a typical 350-650 keV PET scanner energy window used to detect the 511 keV annihilation gamma rays [15], which could lead to excess spurious coincidences within the scanner timing window, and interfere with image quality. ¹³³La has no gamma rays with energies within a typical PET scanner energy window, which should result in no spurious coincidences. Additionally, as previously depicted in Table 2, the much lower activity ratio of ¹³⁵La to ¹³³La produced at 22 MeV, compared to the ratio of ¹³⁵La to ¹³²La produced at 11.9 MeV, should significantly reduce the relative amount of spurious coincidences in the PET scanner energy window from the ¹³⁵La 480.5 keV gamma ray.

Comparing ¹³³La to other PET isotopes in Table 5 shows that its respective mean and maximum positron energies of 0.461 MeV and 1.02 MeV are higher than those of ⁶⁴Cu and ¹⁸F, comparable to those of ¹¹C, and ⁸⁹Zr, and lower than those of ¹³²La, ⁶⁸Ga, ⁴⁴Sc, and ⁸²Rb.

The ubiquitous ¹⁸F has a very low positron energy that provides a sharp image, and ¹¹C has a similar positron energy to ¹³³La. However, the shorter half-lives of ¹⁸F and ¹¹C limit investigating longer biological processes. ⁶⁴Cu has low energy positron emissions, a longer half-life, and β⁻ emissions that enable theranostics, however cyclotron production requires expensive isotopically enriched target material due to the low 0.009% natural abundance of ⁶⁴Zn. ⁸⁹Zr has the longest half-life of the listed isotopes, permitting users to examine longer biological processes, however, it has several high energy gamma rays (909 keV (99%), 1713 keV (0.75%), and 1744 keV (0.12%)), which greatly increase the patient dose and shielding requirements.

⁶⁸Ga has become a widely used radiometal for PET owing to its high positron branching ratio, sufficient half-life, and demonstrated chemistry. ⁶⁸Ga is easily accessible via ⁶⁸Ge/⁶⁸Ga generators, and alternative cyclotron production routes have demonstrated potential to further enhance ⁶⁸Ga supply [10]. However, its higher positron energies compared to ¹³³La, ¹⁸F, and ⁶⁴Cu result in lower imaging spatial resolution [16], and it also has several high energy gamma rays, notably 1077 keV (3.2%), that increase shielding requirements. Despite having a longer half-life than 68 Ga, the higher energy positrons of ⁴⁴Sc compared to ¹³³La, ¹⁸F, and ⁶⁴Cu would also result in a lower image resolution while complicating handling and contributing significantly to patient dose with its 1157 keV (99.9%) gamma-ray emissions.

¹³²La has a similar half-life to ¹³³La. However, it has drawbacks including high positron emission energies and high energy and abundance gamma emissions. ⁸²Rb also has high energy positrons, though this is acceptable given its role in imaging large cardiac structures.

From the previous comparisons, the relatively low positron energies, gamma energies, and gamma abundances of ¹³³La imply higher imaging resolution than ¹³²La, ⁶⁸Ga, ⁴⁴Sc, and a comparable imaging resolution to ¹¹C and ⁸⁹Zr. ¹³³La appears to be an attractive radiometal candidate for PET applications requiring a high scanning resolution, with its relatively long isotopic half-life, ease of handling, and low patient dose. Quantifying ¹³³La dosimetry in future studies is worth pursuing.

TABLE 5
Positron decay characteristics and notable gamma rays
for ¹³³La, ¹³²La, and other common PET isotopes [9].

| | | | | Mean | Maximum | |
|---|---|---|---|---|---|---|
| | | | Positron | Positron | Positron | |
| | Half- | | Branching | Energy | Energy | Gamma Ray Energy and |
| Isotope | Life | | Ratio (%) | (MeV) | (MeV) | Intensity |
| ¹³³La | 3.91 | h | 7.2 | 0.461 | 1.02 | 279 keV (2.4%), 302 keV |
| | | | | | | (1.6%), 291 keV (1.4%), 846 |
| | | | | | | keV (0.4%), 1099 keV (0.2%) |
| ¹³²La | 4.82 | h | 41.2 | 1.29 | 3.67 | 465 keV (76%), 567 keV |
| | | | | | | (15.7%), 1910 keV (9%), 1032 |
| | | | | | | keV (7.8%), 540 keV (7.7%) |
| ¹⁸F | 110 | min | 96.7 | 0.25 | 0.634 | None |
| ⁶⁸Ga | 67.7 | min | 88.9 | 0.829 | 1.9 | 1077 keV (3.2%), 1883 keV |
| | | | | | | (0.14%), 1261 keV (0.1%) |
| ⁶⁴Cu | 12.7 | h | 17.6 | 0.278 | 0.653 | 1345 keV (0.48%) |
| ⁴⁴Sc | 3.97 | h | 94.3 | 0.632 | 1.47 | 1157 keV (99.9%), 1499 keV |
| | | | | | | (0.91%), 2656 keV (0.11%) |
| ⁸⁹Zr | 78.4 | h | 22.7 | 0.396 | 0.902 | 909 keV (99%), 1713 keV |
| | | | | | | (0.75%), 1744 keV (0.12%) |
| ¹¹C | 20.4 | min | 99.8 | 0.386 | 0.96 | None |
| ⁸²Rb | 1.26 | min | 95.4 | 1.48 | 3.38 | 777 keV (15.1%), 1395 keV |
| | | | | | | (0.53%), 698 keV (0.15%), |
| | | | | | | 1475 keV (0.09%) |

Significant advantages arise from our production method and the intrinsic properties of the ^{133/135}La pair, compared to the currently produced ^{132/135}La pair. Our production technique using a 24 MeV cyclotron with a new sealed target design allows high yield on-demand production.

Without an effective sealed target design, the metallic ^{nat}Ba ejects BaO dust into its surroundings as it rapidly oxidizes in the atmosphere, posing a potential radioactive contamination hazard during irradiation and target retrieval. Our sealed target design eliminates this issue through the secure encapsulation of the sensitive ^{nat}Ba target material with a durable bond between the Al target cover, In wire, and Ag disc. Furthermore, the sealed solid target design production method is robust and efficient, and the completed targets are easy to store and handle pre- and post-irradiation.

Irradiated Ag targets became activated with significant activity of ¹⁰⁷Cd, and small activities of ¹⁰⁹Cd, and ^{106m}Ag. Despite the 8.28-day half-life of ^{106m}Ag, after allowing for a several day decay period, residual activity in Ag targets was low enough for target reuse.

Cyclotron irradiations at 22 MeV achieved high-yield production of ¹³³La and ¹³⁵La, while only producing extremely small activities of ¹³²La relative to ¹³³La. Even though there was an appreciable drop in beam energy across the 0.8 mm ^{nat}Ba pellet (22 MeV to 18.3 MeV calculated by SRIM), this did not result in any significant increase in ¹³²La production since the ¹³²Ba(p,n) ¹³²La cross-section remains low across this energy range, and ¹³²Ba has a low isotopic abundance of 0.10%. Avoiding the onset of the higher energy ¹³⁴Ba(p,3n) ¹³²La reaction was important since the 2.42% isotopic abundance of ¹³⁴Ba would produce a much greater activity of the ¹³²La impurity compared to the ¹³²Ba(p,n) ¹³²La reaction. Minimal production of ¹³¹La via the ¹³²La(p,2n) ¹³¹La reaction was observed, with any activity produced significantly decaying during the 3-h post-EOB decay period, due to its 59.2 min half-life. To further reduce radionuclidic impurities, removing the 0.1% of ¹³²Ba natural abundance via isotopic enrichment of ^{nat}Ba should allow the near-complete removal of ¹³²La production from the ¹³²Ba(p,n) ¹³²La reaction and remove ¹³¹La from the ¹³²La(p,2n) ¹³¹La reaction, leaving only ¹³³La and ¹³⁵La after the 3-h decay period. This enriched target material would also enable cyclotrons with an energy lower than 22 MeV to produce radionuclidically pure ^{133/135}La (although at lower production yields). Other isotopic enrichments could potentially increase production yields of ¹³³La or ¹³⁵La. However, the additional cost and availability of enriched Ba target material, as opposed to using relatively inexpensive ^{nat}Ba, would be an important factor to evaluate.

The decay of ¹³³La forms the daughter ¹³³Ba (t_{1/2}=10.6 y), which decays to form stable ¹³³Cs. However, ¹³³Ba activity resulting from the decay of its ¹³³La is comparatively far smaller, and approximately three orders of magnitude below IAEA consignment exemption quantities [13]. Any additional dose from a ¹³³La PET scan resulting from the very small amount of the ¹³³Ba daughter would be minimal due to its extremely low activity resulting from its far longer half-life relative to ¹³³La, low maximum gamma energy of 383 keV, and rapid excretion from the body [17,18]. A study by Newton et al. injected 72.4-79.5 kBq ¹³³Ba into the bloodstream of healthy human volunteers and studied the full-body retention of ¹³³Ba up to 13 y after injection. The majority of injected ¹³³Ba was rapidly cleared from the body (74-90% within 10 d), with residual activity continuously excreted as time progressed.

Additionally, depending on the properties of the targeting vector used to deliver ¹³³La, some of the ¹³³La injected for a PET scan could be excreted before decaying to ¹³³Ba, owing to its 3.92 h half-life. Therefore, pharmacokinetic studies would be useful to assess the in vivo distribution of ¹³³La radiopharmaceuticals and its ¹³³Ba decay daughter. As considered with cyclotron produced 99 mTc, it would be useful to do a future evaluation on the significance of long-lived impurities and decay products on the patient dose [19].

The automated separation of ^{133/135}La from the ^{nat}Ba target material using a NEPTIS unit achieved a decay corrected activity recovery of 88% while producing a highly pure product ready for radiolabeling. In the future, ^{133/135}La radiolabeling and radiopharmaceutical syntheses can be added to the automated synthesis process to create a final product for research or clinical use.

Radiolabeling of DOTA and macropa was successful, with high incorporations observed with each chelator. Concerning chemistry, the production of significant amounts of the “stable” isotopes ¹³⁸La and ¹³⁷La, could provide competition to ^{133/135}La or ^{132/135}La during radiolabeling, since their reaction cross sections are much larger than those of ^{133/135}La at 22 MeV and ^{132/135}La at 11.9 MeV. However, TENDL 2019 reaction cross-sections for the ¹³⁸Ba(p,n) ¹³⁸La, ¹³⁷Ba(p,n) ¹³⁷La, and ¹³⁸Ba(p,2n) ¹³⁷La reactions indicate the amount of ^{137/138}La relative to ^{133/135}La produced at 22 MeV is smaller than that of ^{137/138}La relative to ^{132/135}La produced at 11.9 MeV [12]. This implies that irradiating ^{nat}Ba at 22 MeV could be advantageous over 11.9 MeV from a chemistry perspective, with a lower proportion of “stable” ^{137/138}La isotopes competing during radiolabeling.

^{133/135}La has potential as a theranostic pair for PET imaging and AET in targeted radionuclide therapy. With 11 Auger electrons per decay, ¹³⁵La produces a significant amount of high LET radiation, which is especially suited for killing metastases. With an appropriate targeting vector, ¹³³La could be used to image and ¹³⁵La to kill tumor cells.

Existing low current 11.9 MeV cyclotron ^{132/135}La production requires several-hours of long irradiations to produce small activities for limited pre-clinical applications. In contrast, much higher cross-sections for ^{133/135}La at 22 MeV allow a significantly shorter irradiation time producing over an order of magnitude more ^{133/135}La compared to ^{132/135}La, and significantly, large amounts of ¹³³La relative to ¹³⁵La as previously depicted in Table 2. This large-scale ¹³³La production compensates for the lower positron branching ratio of ¹³³La compared to ¹³²La. Additionally, compared to the small ¹³²La/¹³⁵La ratio shortly after EOB, the far larger ¹³³La/¹³⁵La ratio allows more flexibility with imaging and therapy.

There is a significant potential increase in PET imaging when using the ^{133/135}La product soon after the 3-h decay period post-EOB, as well as allowing large amounts of pure Auger therapy with a longer decay period after EOB.

A typical 18F activity of 300-400 MBq is used for clinical PET imaging [20], and a typical 68 Ga activity of 1.59 MBq/kg is suggested [21]. It would be a challenge to produce a ¹³²La activity equivalent to a typical 18F or 68 Ga dose with current ^{132/135}La production methods unless isotopically enriched Ba target material was used. In contrast, it should be far easier to reach a clinically relevant ^{133/135}La activity with a 22 MeV irradiation of a ^{nat}Ba target. The much greater yield of ^{133/135}La with our 22 MeV higher energy production method should enable clinically relevant amounts of activity to be produced with relatively short irradiations.

It should be noted that not all PET centers have access to a cyclotron that can reach 22 MeV, so ^{133/135}La production will be limited to those centers with sufficiently high beam energy. However, the relatively long half-lives of ¹³³La (3.9 h) and ¹³⁵La (19.5 h) would permit regional distribution of the ^{133/135}La theranostic pair.

### CONCLUSION

We have developed a high yield and cost-effective method of producing a novel theranostic pair, ^{133/135}La. Our production technique uses a new type of sealed solid target that is robust, simple to manufacture, significantly improves target handling, and contains reusable components. Production yields of ^{133/135}La at 22 MeV are over an order of magnitude higher than existing ^{132/135}La production techniques, enabling clinically relevant ^{133/135}La activities to be produced at low cyclotron beam currents and relatively short irradiation times, without expensive isotopically enriched Ba target material. ^{133/135}La shows intriguing imaging potential due to its much lower positron energy and far lower gamma-ray energies and abundances compared to ^{132/135}La, with potential applications for treating cancer metastases as a PET/AET theranostic pair. Accordingly, ^{133/135}La appears to be an attractive radiometal theranostic candidate for PET applications requiring high scanning resolution, a relatively long half-life, ease of handling, and lower patient dose. This study demonstrated the potential for high-yield ^{133/135}La production via ^{nat}Ba irradiation at sites with a medical cyclotron that can reach 22 MeV, meeting increasing demands for pre-clinical and potential clinical applications for ^{133/135}La radiopharmaceuticals.

### REFERENCES

1. Velikyan I. Molecular imaging and radiotherapy: theranostics for personalized patient management. Theranostics. 2012; 2(5):424-426.
2. Poty S, Francesconi L C, McDevitt M R, Morris M J, Lewis J S. α-Emitters for Radiotherapy: From Basic Radiochemistry to Clinical Studies-Part 1. J Nucl Med. 2018; 59(6):878-884.
3. Kassis Al. Molecular and cellular radiobiological effects of Auger emitting radionuclides. Radiat Prot Dosimetry. 2011; 143(2-4):241-247.
4. Ku A, Facca V J, Cai Z, Reilly R M. Auger electrons for cancer therapy a review. EJNMMI Radiopharm Chem. 2019;4(1):27. Published 2019 Oct. 11.
5. Aluicio-Sarduy E, Hernandez R, Olson A P, et al. Production and in vivo PET/C T imaging of the theranostic pair 132/135La. Sci Rep. 2019;9(1):10658.
6. Aluicio-Sarduy E, Thiele N A, Martin K E, et al. Establishing Radiolanthanum Chemistry for Targeted Nuclear Medicine Applications. Chemistry. 2020; 26(6):1238-1242.
7. Fonslet J, Lee B Q, Tran T A, et al. 135La as an Auger-electron emitter for targeted internal radiotherapy. Phys Med Biol. 2017;63(1):015026. Published 2017 Dec. 29.
8. Kratochwil C, Bruchertseifer F, Giese! F L, et al. 225Ac-PSMA-617 for PSMA-Targeted α-Radiation Therapy of Metastatic Castration-Resistant Prostate Cancer. J Nucl Med. 2016; 57(12):1941-1944.
9. Sonzogni, A. and Shu, B., 2020. Nudat 2.8 (Nuclear Structure And Decay Data). [online] Nndc.bnl.gov. Available at: <https://www.nndc.bnl.gov/nudat2/reCenter.jsp?z=56&n=77>[Accessed 8 Sep. 2020].
10. Nelson B J B, Wilson J, Richter S, Duke M J M, Wuest M, Wuest F. Taking cyclotron 68Ga production to the next level: Expeditious solid target production of 68Ga for preparation of radiotracers. Nucl Med Biol. 2020;80-81:24-31.
11. Ziegler J F, Ziegler M D, Biersack J P, 2009. The stopping and range of ions in matter (SRIM code, version 2013.00). <http://www.srim.org/>.
12. Rochman D, Koning A J, Sublet J C, Fleming M, Bauge E, Hilaire S, et al. The TENDL library: hope, reality and future. Proceedings of the International Conference on Nuclear Data for Science and Technology; 2016. p. 146.
13. INTERNATIONAL ATOMIC ENERGY AGENCY, Regulations for the Safe Transport of Radioactive Material, IAEA Safety Standards Series No. SSR-6 (Rev.1), IAEA, Vienna (2018).
14. Levin C S, Hoffman E J. Calculation of positron range and its effect on the fundamental limit of positron emission tomography system spatial resolution. Phys Med Biol. 1999;44(3):781.
15. Ferguson S, Jans H S, Wuest M, Riauka T, Wuest F. Comparison of scandium-44 g with other PET radionuclides in pre-clinical PET phantom imaging. EJNMMI Phys. 2019;6(1):23. Published 2019 Dec. 12.
16. Pourmand A, Dauphas N. Distribution coefficients of 60 elements on TODGA resin: application to Ca, Lu, Hf, U and Th isotope geochemistry. Talanta. 2010; 81(3):741-753.
17. Moffett, D., Smith, C., Stevens, Y., Ingerman, L., Swarts, S., & Chappell, L. (2007). Toxicological profile for barium and barium compounds. Agency for toxic substances and disease registry (pp. 1-231). Atlanta, Georgia: U S Department of Health and Human Services.
18. Newton D, Ancill A K, Naylor K E, Eastell R. Long-term retention of injected barium-133 in man. Radiation Protection Dosimetry. 2001; 97(3):231-240.
19. Andersson J D, Thomas B, Selivanova S V, et al. Robust high-yield ˜1 TBq production of cyclotron based sodium [99mTc]pertechnetate. Nucl Med Biol. 2018; 60:63-70.
20. Fludeoxyglucose F 18 Injection—FDA NDA 21-870. (n.d.). Retrieved from https://www.accessdata.fda.gov/drugsatfda_docs/labe1/2005/0218701bl.pdf
21. HIGHLIGHTS OF PRESCRIBING INFORMATION—Ga 68 DOTATOC INJECTION. (2019, August). Retrieved from https://www.accessdata.fda.gov/drugsatfda_docs/labe1/2019/210828s0001bl.pdf

Supplemental Information

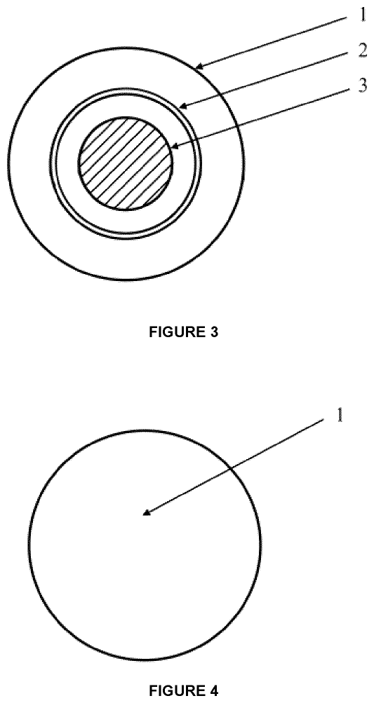

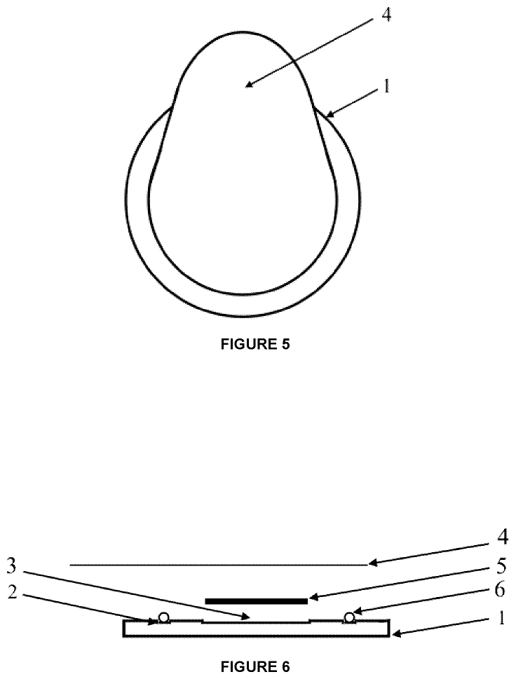

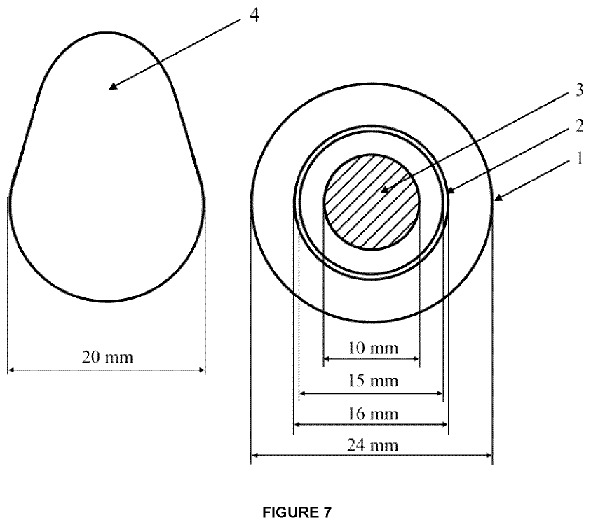

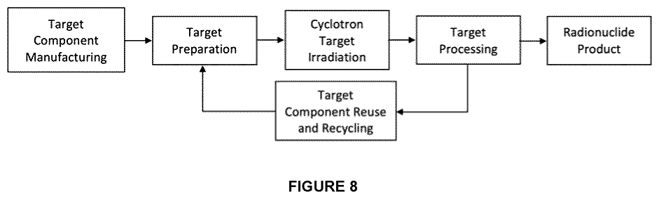

This disclosure is for a sealed solid cyclotron target design for producing radionuclides on medical cyclotrons, and is especially useful for producing radionuclides using hazardous or radioactive target material. A target is depicted in FIGS. 3-7, and the target process flow is depicted in FIG. 8.

### BACKGROUND AND SUMMARY

This sealed solid target technology is advantageous over existing forms of cyclotron targetry. Cyclotron gas and liquid targets have been employed to produce radionuclides. However, they suffer from low target material density leading to lower radionuclide yields, and issues related to cavitation, heat transfer, salt precipitation, and changing solution concentrations. Solid targets solve many of these issues, allowing a slim and smaller design due to higher target material density, which permits much higher radionuclide yields per target mass and volume.

Existing solid targets typically involve bombarding the target backing itself, or attaching target material to a backing for support, where in either case the target material is exposed to the atmosphere. For the latter method, target material is often deposited in a deep depression in a target backing and rushed to installation for cyclotron irradiation or storage in an inert gas to avoid oxidation and physical/material property changes.

These existing approaches limit target assembly and radionuclide production workflows since they have target material exposed to the atmosphere during manufacturing, cyclotron irradiation, and retrieval for post-irradiation processing. This permits hazardous target material, especially the group 2 metals, to react with the atmosphere and oxidize. This is an issue, since target material changes chemical structure upon oxidation which can lead to mechanical disintegration prior to, during, or after irradiation. The former presents a storage and installation issue, and the latter two present significant radioactive contamination hazards to the cyclotron target assembly, operator, and other facility infrastructure.

Existing, custom built sealed cyclotron target assemblies can be used to encapsulate target material for cyclotron irradiation. However, these assemblies (for gas, liquid, and solid targets), are often large, take significant effort and materials to manufacture, contain multiple seals (potential points of failure), and use excessive amounts of target material to achieve an equivalent radionuclide production. Additionally, existing target assemblies are often custom designed for a specific target material and radionuclide production.

The described silver-aluminum-indium target assembly is advantageous since it is also designed with subsequent processing in mind for target materials reactive with water, such as the group 2 metals, and water-soluble oxides such as barium oxide, calcium oxide, and strontium oxide. Since these materials are highly reactive or soluble in water, and the other metals used in the target assembly are not, target material dissolution in water is possible thereby enabling selective removal from the other metals of the target assembly.

This design using water as a dissolution medium is advantageous for target processing of group 2 metals, since it avoids using highly reactive reagents for processing such as hydrochloric or nitric acid. Additionally, hazardous or radioactive target material such as radium-226 cannot be used in existing open-air solid target assemblies, which may result in larger target assemblies or liquid targetry being employed, making this target design an attractive alternative. By utilizing this novel solid target assembly, targets can be manufactured and stored for long periods of time, irradiated and retrieved for processing without risk of target material degradation or radioactive contamination. Additionally, the target design is small and compact, permitting ease of manufacturing and assembly, transport, target irradiation, and processing, compared to other gas, liquid, or solid target assemblies.

The target assembly backing can be made of any metal with sufficient thermal conductivity, such as silver, copper, gold, platinum, aluminum, or niobium. This backing should be conducive to target material dissolution conditions in water or acids (ex. water—all backings, hydrochloric acid—silver, nitric acid—aluminium, etc.). Using a silver target backing as opposed to other metals such as platinum allows for low-cost target manufacturing and has demonstrated minimal Cadmium-107/109 nuclear by-products, allowing for multiple reuses of the target backing. The aluminum cover facilitates easy removal for processing via its peel-off tab, avoiding complex target transfer systems.

This novel sealed target assembly is especially suitable for production of a variety of radionuclides for use in positron emission tomography (PET) such as radioscandium (scandium-44/47), radiolanthanum (lanthanum-132/133/135), radioyttrium (yttrium-86), radiolead (lead-201/203) by cyclotron proton beam bombardment of reactive and water-soluble target materials (barium/calcium/strontium metal, barium/calcium/strontium/thallium oxide). The sealed target assembly also permits production of actinium-225, an attractive alpha particle emitting cancer therapeutic radionuclide undergoing clinical trials, by proton bombardment of radioactive radium-226 chloride target material.

### DETAILED DESCRIPTION

FIGS. 3-7 depict the sealed target assembly. The target consists of a circular silver (or other metal with sufficient thermal conductivity) target backing (24-40 mm in diameter, 1-2 mm thick), indium wire (1-2 mm diameter), a target material pellet (10-15 mm in diameter, 0.4-1 mm thick) and an aluminum cover (or other metal with excellent thermal conductivity) (20-35 mm diameter, 0.025-0.250 mm thick) with a removal tab.

A circular 10-15 mm diameter depression is machined into the center of the silver backing to a depth of up to 0.4 mm to hold the target material pellet. The silver target is intentionally left rough to promote mechanical adhesion of the target material and indium wire to the target backing. A 1-2 mm wide annulus with an inner diameter of 15-25 mm and outer diameter of 16-27 mm is machined to a depth of 0.1-0.6 mm to hold the indium wire seal.

The cyclotron target material is placed into the central depression, in the form of a metallic pellet, oxide, salt, or spotted on as a liquid and allowed to dry. This method of target manufacture affords great flexibility by allowing a wide variety of target materials to be used for producing various radionuclides. Metallic target pellets are produced using a 10-15 mm diameter piston die set and hydraulic press and sintered to enhance ductility and pellet robustness. Pellets are produced to be 10-15 mm in diameter and 0.4-1 mm thick and are secured into the central target depression using a hydraulic press to achieve a tight and firm fit.

Indium wire is laid along the circumference of the annulus groove, with the excess length overlapping side by side at the ends. The aluminum cover is then centered on top of the assembly and pressed onto the target at ˜25 kN of force using a hydraulic press. This compression spreads the indium wire (held in place by the annulus groove), with the indium forming a mechanical bond between the target backing and aluminum cover, thereby sealing the target material inside the target assembly. This allows hazardous and rapidly oxidizing target material, especially the group 2 metals such as calcium, strontium, and barium, to be prepared as targets and stored to take advantage of their metallic solid form. This design also has potential for use with water soluble metal oxides, and radioactive target material such as radium-226, where the material can be prepared in a sealed and safe target. It can also prevent post-irradiation radioactive contamination for target material, which could become unstable and prone to partial or complete delamination from the target assembly after irradiation.

The aluminum sealing cover is thick enough to maintain structural and seal integrity, yet thin enough to avoid excessive cyclotron beam energy degradation (see Table 1), facilitate excellent heat transfer to the target backing to avoid thermal failure, and maintain sufficient flexibility for convenient mechanical removal after target irradiation.

Aluminum was selected as the target cover material due to its excellent thermal conductivity, low cost, and minimal activation and production of undesirable radionuclides in the proton energy range of medical cyclotrons (typically E<24 MeV). The aluminum cover also serves as a built-in degrader to lower the cyclotron beam energy. Therefore, the aluminum cover thickness can be selected to produce a desired beam energy degradation to optimize the nuclear reactions occurring within the encapsulated target material pellet. The target cover may also be made using other sufficiently malleable metals, such as copper.

Indium was selected due to its excellent ductility, malleability, thermal conductivity, low cost, and ability to form robust metal-metal mechanical seals for thermally demanding applications. The annulus groove is machined with sufficient distance from the target material depression so when the indium wire is compressed and forms the seal, it remains outside of the cyclotron target beam spot (which is centered over and approximately the same size as the target material depression), avoiding indium activation and nuclear by-products.

Since the aluminum target cover contacts the front of the target pellet, the indium wire seal supplements the heat transfer between the back of the pellet and the silver target backing. The indium weld between the target cover and backing enhances heat transfer from the front side of the pellet to the cover to the backing where heat is then removed by cooling water flowing along the silver backing. The indium bond results in greater heat transfer compared to just an aluminum-sliver contact interface.

Besides providing an excellent physical seal to contain the radioactive material, this results in a clear heat transfer advantage over other open cyclotron target designs (such as target material directly exposed to the beamline vacuum) or existing sealed target designs (whose target covers are held to target backings just by pressure). The additional heat transfer from both sides of the target pellet should enable cyclotron higher beam currents over these existing target designs, and therefore greater radionuclide production.

Indium wire is employed in heat-intensive electronics applications to enhance thermal conductivity by eliminating rough interfacing surfaces on a micromaterial scale. Indium fills microscopic voids in both metallic surfaces when welding them together, increasing contact surface area and therefore thermal conductivity compared to just pressing two metallic surfaces tightly together. Indium is used in other industries (such as petrochemical) for specialty sealing applications (such as cryogenic natural gas processing equipment) that require a robust bond and seal between metals experiencing a wide range of temperatures. In this instance, indium is superior to using elastomeric o-rings in a sealed target assembly.

Natural indium consists of two stable isotopes In-113 (4.3%) and In-115 (95.7%). While cyclotron irradiation can result in the production of tin radioisotopes from indium, notably long-lived Sn-113 (115 day half-life), this is a minimal concern since the indium wire is separated sufficiently from the cyclotron beam spot to avoid activation. Since tin does not react with water, any tin radioisotopes produced will remain within the indium wire during subsequent target dissolution and processing. Our group has experience handling Sn-113 produced in existing gas targets with indium components.

1-2 mm diameter indium wire was selected since it provides sufficient contact surface area for a robust seal and durable bond between two metals when spread under pressure. This avoids an oversized seal that spreads into the cyclotron beam spot when pressed and an excessively strong bond that makes aluminum cover removal difficult, while also avoiding too small a surface area that risks loss of seal and/or premature separation of the aluminum cover.

The above sealed solid target is not limited to bombardment by proton beams, but can also be used for cyclotrons accelerating other charged particles, such as deuterons and alpha-particles.

Development

Over twenty targets have been machined and fully assembled containing different target materials, including inert yttrium metal for zirconium-89 radiometal production, zinc-68 metal for copper-64 production, thallium metal for lead-201 production, and rapidly oxidizing natural barium metal, barium oxide, and barium carbonate for producing lanthanum-132/133/135. These targets have been reused many times for multiple cyclotron irradiations. Over 100 successful irradiations have been performed with the sealed target assembly design, with the targets performing exceptionally well, maintaining their seals with no signs of physical degradation.

Post-irradiation, the target was transported to processing where the aluminum cover was peeled back with a pair of long tongs (to minimize radiation exposure), and the target placed in distilled water. The barium metal reacted with the water, forming an aqueous barium solution ready for further processing. After target material has dissolved or dissociated, the target components remained intact for retrieval and reuse. Post-processing, the barium solution's gamma ray spectrum was analyzed on a high-purity germanium detector (HPGe), which confirmed high-purity of lanthanum 132/135 radioisotopes from barium metal and barium carbonate irradiation.

This novel solid cyclotron target design allows streamlined manufacture of targets with reactive or radioactive target material that can be stored safely for long periods of time while maintaining their unreacted/unoxidized form. This sealed target design also reduces the likelihood of radioactive contamination from solid targets with inert target material that could become unstable during or after cyclotron irradiation and detach from an unsealed solid target.

Figures and Tables:

Figure component legend:

(1) Target backing (silver, or other sufficiently conductive metal).

(2) Machined annulus groove for indium wire.

(3) Machined depression for target material pellet.

(4) Aluminum target cover with protruding flap to facilitate peeling and removal.

(5) Target material pellet prior to pressing in the depression.

(6) Indium wire in the machined annulus prior to pressing and bonding.

TABLE 6
Cyclotron proton beam energy degradation as a function
of initial beam energy across varying aluminum cover
thicknesses (calculated using SRIM 2013).

| | 0.250 mm | 0.125 mm | 0.025 mm |
|---|---|---|---|
| | Al Exiting | Al Exiting | Al Exiting |
| Initial Beam | Beam Energy | Beam Energy | Beam Energy |
| Energy (MeV) | (MeV) | (MeV) | (MeV) |
| 24 | 22.8 | 23.4 | 23.9 |
| 20 | 18.6 | 19.3 | 19.9 |
| 16 | 14.4 | 15.2 | 15.8 |
| 12 | 9.84 | 11 | 11.8 |

The embodiments described herein are intended to be examples only.

Alterations, modifications and variations can be effected to the particular embodiments by those of skill in the art. The scope of the claims should not be limited by the particular embodiments set forth herein, but should be construed in a manner consistent with the specification as a whole.

All publications, patents and patent applications mentioned in this Specification are indicative of the level of skill those skilled in the art to which this invention pertains and are herein incorporated by reference to the same extent as if each individual publication patent, or patent application was specifically and individually indicated to be incorporated by reference.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

What is claimed is:

1. A cyclotron target, comprising:
a target backing (1), comprising an inner surface and an outer surface, the inner surface defining a target material depression (3) sized to receive a target material pellet, the inner surface defining an annular groove (2) sized to receive a wire seal element,
a wire seal element (6) disposed within the annular groove (2),
a target cover (4) removably fixed to the target backing (1) and defining an inner volume said target cover (4), and optionally comprising a removal tab for removing at least a portion of said target cover (4) from said target backing (1).

2. The sealed cyclotron target of claim 1, further comprising a target material pellet disposed within said target material depression (3).

3. The cyclotron target of claim 1 or 2, wherein said target backing comprises, consists of, or is, silver, copper, niobium, gold, aluminum, or platinum.

4. The sealed cyclotron target of any one of claims 1 to 3, wherein said target backing is generally circular, having a diameter of about 22 mm to about 44 mm, and a thickness of about 1 mm to about 2 mm.

5. The cyclotron target of any one of claims 1 to 3, wherein the target material depression (3) is generally circular with a diameter of 10-15 mm and depth up to 0.4 mm.

6. The cyclotron target of any one of claims 1 to 5, wherein the annular groove comprises a 1-2 mm wide annulus with an inner diameter of 15-25 mm, an outer diameter of 16-27 mm, and a depth of 0.1-0.6 mm.

7. The cyclotron target of any one of claims 1 to 6, wherein the wire seal element has a diameter of about 1-2 mm.

8. The cyclotron target of any one of claims 1 to 7, wherein the wire seal element comprises, consists of, or is, indium.

9. The cyclotron of any one of claims 1 to 8, wherein the target material pellet comprises a metallic pellet, oxide, salt, or spotted on as a liquid and allowed to dry.

10. The cyclotron of any one of claims 1 to 9, wherein the target material is a target material pellet between about 0-15 mm in diameter and 0.4-1 mm thick.

11. The cyclotron of any one of claims 1 to 10, wherein the target cover comprises, consists of, or is, aluminum or copper.

12. The cyclotron target of any one of claims 1 to 11, wherein the target cover has a diameter of about 20-35 mm and a thickness of about 0.025-0.250 mm.

13. A method of manufacturing a cyclotron target, comprising:
providing a target backing (1) comprising an inner surface and an outer surface, the inner surface defining a target material depression (3) sized to receive a target material pellet, the inner surface defining an annular groove (2) sized to receive a wire seal element.
securing a target material in the target materials depression (3),
placing a wire seal element in the annular groove (2),
securing a target cover to the target backing (1).

14. The method of claim 13, wherein the securing of the target materials comprises applying force to said target materials when disposed in said target material depression.

15. The method of claim 14, wherein said force is applied is about 20 kN.

16. The method of claim 14 or 15, wherein said force is applied using a hydraulic press.

17. The method of any one of claims 13 to 16, wherein securing the target cover comprises applying a force of about 25 kN to target cover on the inner surface of target backing.

18. The method of claim 17, wherein said force is applied using a hydraulic press.

19. A method of producing a radionuclide for use in position emission tomography (PET), comprising: irradiating a cyclotron target of any one of claims 1 to 12 at 22 MeV, for 25-200 min with a maximum proton beam current of 20 μA at current densities of 25.5 μA/cm².

20. The method of claim 19, wherein said irradiating is carried out using a 24 MeV T R-24 cyclotron.

21. A method of producing ^{133/135}La, comprising: irradiating a cyclotron target of any one of claims 1 to 12 at about 22 MeV, wherein the target material is ^{nat}Ba metal.

22. A kit, comprising:
a target backing (1), comprising an inner surface and an outer surface, the inner surface defining a target material depression (3) sized to receive a target material pellet, the inner surface defining an annular groove (2) sized to receive a wire seal element,
a wire seal element (6) disposed within the annular groove (2),
a target cover (4) removably fixed to the target backing (1) and defining an inner volume said target cover (4), and optionally comprising a removal tab for removing at least a portion of said target cover (4) from said target backing (1).

23. The kit of claim 22, further comprising a target material pellet disposed within said target material depression (3).

24. The kit of claim 22 or 23, wherein said target backing comprises, consists of, or is, silver, copper, niobium, gold, aluminum, or platinum.

25. The kit of any one of claims 22 to 24, wherein said target backing is generally circular, having a diameter of about 22 mm to about 44 mm, and a thickness of about 1 mm to about 2 mm.

26. The cyclotron target of any one of claims 22 to 25, wherein the target material depression (3) is generally circular with a diameter of 10-15 mm and depth up to 0.4 mm.

27. The cyclotron target of any one of claims 22 to 26, wherein the annular groove comprises a 1-2 mm wide annulus with an inner diameter of 15-25 mm, an outer diameter of 16-27 mm, and a depth of 0.4-0.6 mm.

28. The cyclotron target of any one of claims 22 to 27, wherein the wire seal element has a diameter of about 1-2 mm.

29. The cyclotron target of any one of claims 22 to 28, wherein the wire seal element comprises, consists of, or is, indium.

30. The cyclotron of any one of claims 22 to 29, wherein the target material pellet comprises a metallic pellet, oxide, salt, or spotted on as a liquid and allowed to dry.

31. The cyclotron of any one of claims 22 to 30, wherein the target material is a target material pellet between about 0-15 mm in diameter and 0.4-1 mm thick.

32. The cyclotron of any one of claims 22 to 31, wherein the target cover comprises, consists of, or is, aluminum or copper.

33. The cyclotron target of any one of claims 22 to 32, wherein the target cover has a diameter of about 20-35 mm and a thickness of about 0.025-0.250 mm.
